(19) United States
(12) Patent Application Publication
(10) Pub. No.: US 2005/0104988 A1
(43) Pub. Date: May 19, 2005

(54) DIGITAL IMAGE CAPTURING SYSTEM AND METHOD FOR CONTROLLING THE SIZE OF A CAPTURED IMAGE

(76) Inventors: Keng-Ming Su, Taipei City (TW); Ying-Hao Hsu, Chi-Lung City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,571

(22) Filed: Nov. 17, 2004

(30) Foreign Application Priority Data
Nov. 18, 2003 (TW) 092132298

(51) Int. Cl. H04N 5/222

(52) U.S. Cl. 348/333.12

(57) ABSTRACT

An image-capturing system includes a lens for capturing an image, a storage module for storing the image, a display module for displaying the image captured by the lens, and a logical unit for displaying an image-capturing frame on the display module, selecting a section of the image displayed on the display device within the image-capturing frame, and storing the selected section of the image in the storage module.

### BACKGROUND OF INVENTION

1. Field of the Invention

The present invention relates to an image-capturing system and a related method, and more particularly, to an image-capturing system and a method for controlling the size of the captured image.

2. Description of the Prior Art

Digital cameras have become popular digital products and are positioned to eventually replace conventional film cameras due to low prices and compatibility with other electronic peripherals. The digital camera differs from conventional film cameras by providing an electrical viewfinder. Users can view the image of the object on the electrical viewfinder instead of a smaller optical viewfinder. In addition, the users can use the electrical viewfinder to browse the images after shooting.

Please refer to FIG. 1. FIG. 1 is a front view diagram illustrating a conventional first digital camera 10 according to the prior art. The first digital camera 10 includes a camera lens 12 for capturing an object, an optical viewfinder 14 composed of several lenses for users to view the image of an object refracted by the lenses, and a shutter button 16 for focusing and shooting. Please refer to FIG. 2. FIG. 2 is a rear view diagram of the first digital camera 10 according to the prior art. The first digital camera 10 further includes an electrical viewfinder 18 providing users with another option to view the image of the object, which can be a liquid crystal display (LCD) or a low temperature polysilicon (LTPS) display. A control button set 20 is for users to browse and edit images or to set up parameters. The first digital camera 10 differs from conventional film cameras by providing the electrical viewfinder 18. Users can operate the control button set 20 to view the image of the object on the electrical viewfinder 18 instead of using the smaller optical viewfinder 14. In addition, the users can use the electrical viewfinder 18 to browse the images after shooting.

Please refer to FIG. 3. FIG. 3 is a functional block diagram of the first digital camera 10 according to the prior art. The first digital camera 10 further includes an image sensor 22 for converting receiving optical signals into electrical signals. If there are more pixels of the image sensor 22, the resolution of the captured image can be higher. The image sensor 22 can be a charge coupled device (CCD) or a complementary metal-oxide semiconductor (CMOS) image sensor. The first digital camera 10 further includes a digital signal processor 24 for processing image signals, and a storage module 26 for storing images. The storage module 26 can be a flash memory, such as a CF card or a SD card, a read-only memory, such as an optical disk, a micro drive, and so on.

The camera lens 12 can receive light of the object and focus the light on the image sensor 22, and the image sensor 22 can convert the optical signal of the light into an electrical signal and transmit the electrical signal to the digital signal processor 24. The digital signal processor 24 can store the image signal in the storage module 26 and transmit the image signal to the electrical viewfinder 18 for users to browse or edit the image.

The size of the image captured by the first digital camera 10 is based on the amount of pixels of the image sensor 22. Different image sizes can be chosen using a fixed aspect ratio for enlarging or reducing images in a fixed ratio so as to maintain the same rate of the field of view. For example, as to the image sensor 22 with two million pixels, the size of captured images can be set for 1600×1200, 800×600, or 640×480. That is, the aspect is 4:3, and the rate of the field of view of the captured image is the same as the dynamic preview image on the optical viewfinder 14 and on the electrical viewfinder 18. If the user only wants to select a section of the preview image on the optical viewfinder 14 or on the electrical viewfinder 18 or wants to obtain an image at a different aspect ratio, the user has to capture an image in the fixed aspect ratio presented on the optical viewfinder 14 or on the electrical viewfinder 18 first, transmit the image to a computer via a connect port of the first digital camera 10 secondly, and use an image processing software in the computer to modify the image so as to obtain the image at a different aspect ratio or in a specific size. However, it is very inconvenient for users, especially to capture a passport size photograph.

### SUMMARY OF INVENTION

It is therefore a primary objective of the claimed invention to provide an image-capturing system and a method for controlling the size of the captured image to solve the above-mentioned problems.

According to the claimed invention, an image-capturing system includes a lens for capturing an image, a storage module for storing the image, a display module for displaying the image captured by the lens, and a logical unit for displaying an image-capturing frame on the display module, selecting a section of the image displayed on the display device within the image-capturing frame, and storing the selected section of the image in the storage module.

According to the claimed invention, a method for capturing part of an image includes the steps of capturing the image, displaying the image, displaying an image-capturing frame, utilizing the image-capturing frame for selecting a section of the image, and storing the selected section of the image.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a front view diagram illustrating a conventional first digital camera.

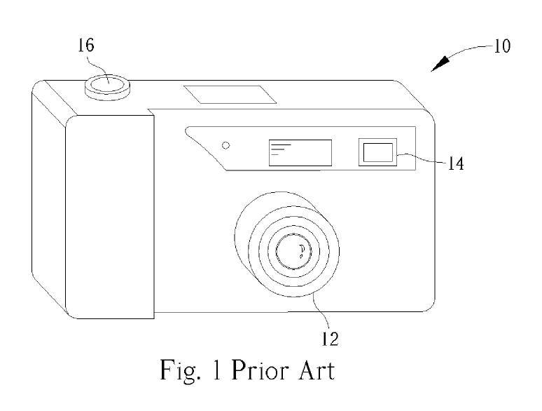

FIG. 2 is a rear view diagram of the first digital camera.

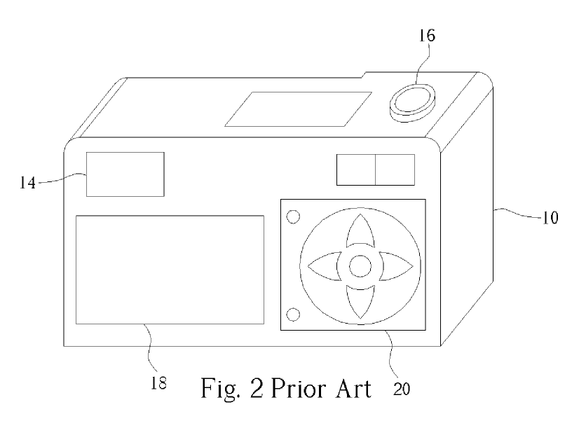

FIG. 3 is a functional block diagram of the first digital camera.

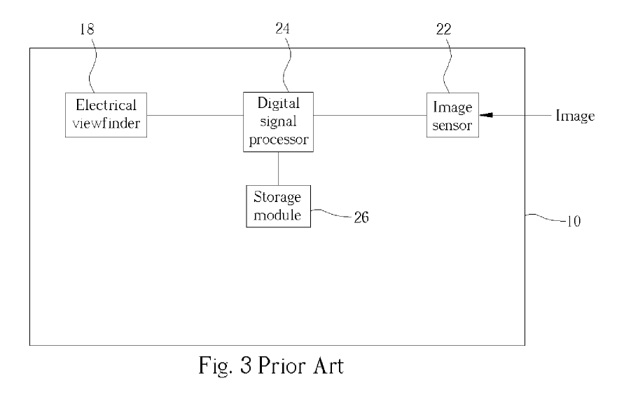

FIG. 4 is a front view diagram illustrating a second digital camera.

FIG. 5 is a rear view diagram of the second digital camera.

FIG. 6 is a functional block diagram of the second digital camera.

FIG. 7 is a flowchart illustrating the second digital camera capturing an image.

FIG. 8 is a diagram illustrating a first image displayed on an electrical viewfinder.

FIG. 9 is a diagram of a second image.

FIG. 10 is a diagram of a third image.

### DETAILED DESCRIPTION

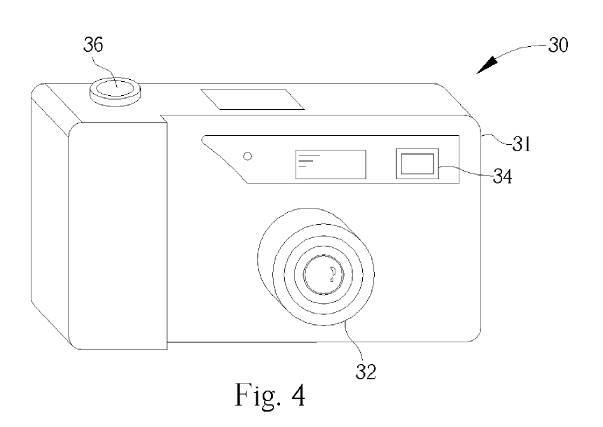

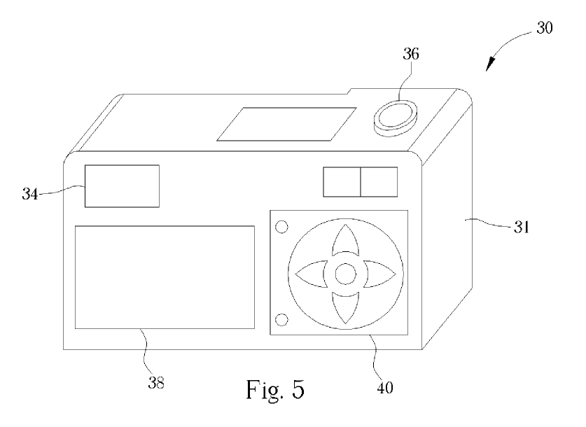

Please refer to FIG. 4. FIG. 4 is a front view diagram illustrating a second digital camera 30. The second digital camera 30 includes a housing 31, a camera lens 32 for capturing an object, an optical viewfinder 34 installed on the housing 31 and composed of several lenses for users to view the image of an object refracted by the lenses, and a shutter button 36 for focusing and shooting. Please refer to FIG. 5. FIG. 5 is a rear view diagram of the second digital camera 30. The second digital camera 30 further includes an electrical viewfinder 38 installed on the housing 31 for providing users with another option to view the image of the object, which can be a liquid crystal display (LCD) or a low temperature polysilicon (LTPS) display. A control button set 40 is for users to browse and edit images or to setup other parameters.

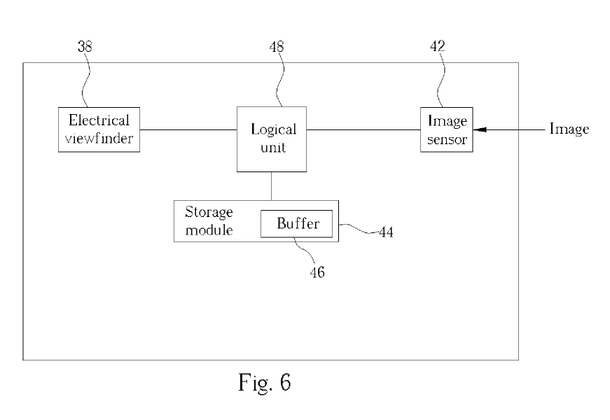

Please refer to FIG. 6. FIG. 6 is a functional block diagram of the second digital camera 30. The second digital camera 30 further includes an image sensor 42 for converting receiving optical signals into electrical signals. If there are more pixels of the image sensor 22, the resolution of the captured image can be higher. The image sensor 42 can include a charge coupled device (CCD) or a complementary metal-oxide semiconductor (CMOS) image sensor. The second digital camera 30 further includes a storage module 44 for storing images, which can be a flash memory, such as a CF card or a SD card, a read-only memory, such as an optical disk, a micro drive, and so on. The storage module 44 includes a buffer 46 for storing the image captured by the camera lens 32 temporarily. The buffer 46 can be designed as a storage device independent of the storage module 44. The second digital camera 30 further includes a logical unit electrically connected to the image sensor 42, the electrical viewfinder 38, and the storage module 44 for processing captured images, displaying an image-capturing frame on the electrical viewfinder 38, selecting a section of the image captured by the camera lens 32 and displayed on the electrical viewfinder 38 within the image-capturing frame, and storing the selected section of the image within the image-capturing frame in the storage module 44.

The camera lens 32 can receive light of the object and focus the light on the image sensor 42, and the image sensor 42 can convert the optical signal of the light into an electrical signal and transmit the electrical signal to the logical unit 48. The logical unit 48 can store the image signal in the storage module 44 and transmit the image signal to the electrical viewfinder 38 so that users can browse or edit the image.

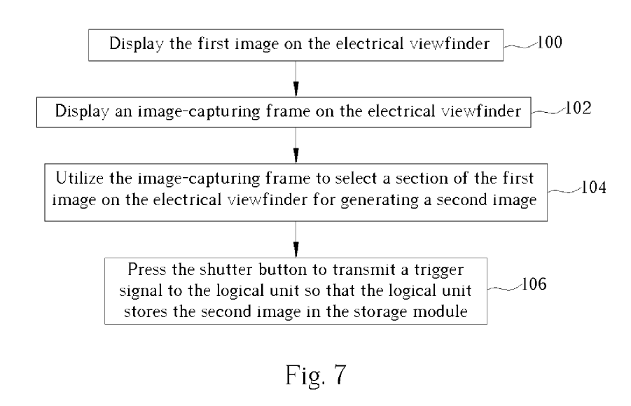

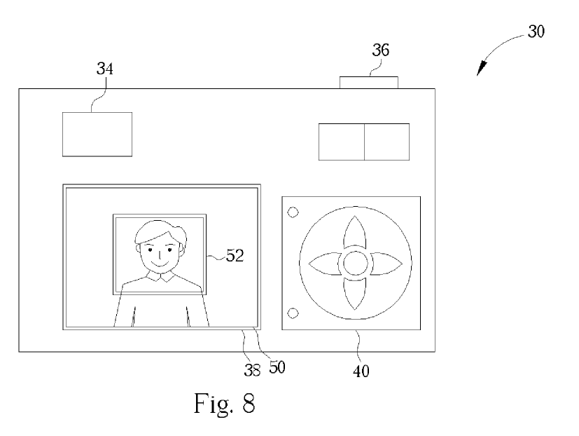

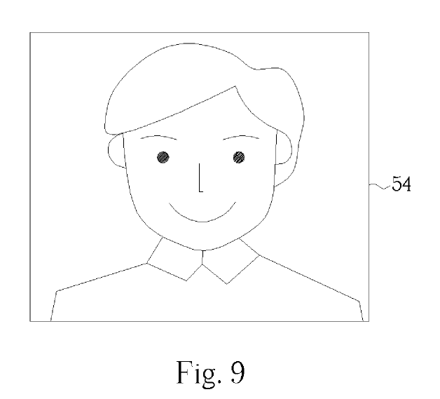

Please refer to FIG. 7, FIG. 8, and FIG. 9. FIG. 7 is a flowchart illustrating the second digital camera 30 capturing an image. FIG. 8 is a diagram illustrating a first image 50 displayed on the electrical viewfinder 38. FIG. 9 is a diagram of a second image 54. The method of the second digital camera 30 capturing an image includes the following steps:

Step 100: Display the first image 50 captured by the camera lens 32 of the second digital camera 30 on the electrical viewfinder 38.

Step 102: Display an image-capturing frame 52 on the electrical viewfinder 38.

Step 104: Utilize the image-capturing frame 52 to select a section of the first image 50 on the electrical viewfinder 38 for generating a second image 54.

Step 106: Press the shutter button 36 to transmit a trigger signal to the logical unit 48 so that the logical unit 48 stores the second image 54 in the storage module 44.

The defining characteristic of the present invention is storing the specific section of the first image 50, which is the second image 54 previewed on the electrical viewfinder 38, instead of storing the entire first image 50 in the storage module 44 after pressing the shutter button 36. The location and the size of the section of the first image 50 depend on the selecting area within the image-capturing frame 52 and are not fixed. The user can even set a default value of the location and the size of the image-capturing frame 52 and load the default value when shooting.

The detailed description of the above-mentioned steps is introduced as follows. First the camera lens 32 can receive the light of the first image 50 and focus the light on the image sensor 42, and then the image sensor 42 converts the optical signal into an electrical signal and transmits the electrical signal to the logical unit 48. The logical unit 48 can transmit the image signal of the first image 50 to the electrical viewfinder 38 for displaying the first image 50. The user can operate the control button set 40 to set the size and the location of the image-capturing frame 52. In addition, several default settings of the image-capturing frame 52 can be built in the second digital camera 30 before leaving the factory, such as a two-inch or one-inch passport size photograph. The user only has to choose one of the default settings with the control button set 40, and the image-capturing frame 52 of the default size can be displayed on the electrical viewfinder 38. The image within the image-capturing frame 52 can be captured as a passport size photograph for printing. Similarly a 3×5 or 4×6 photograph dimension can be used as a default setting for printing photographs conveniently. The user also can set the size and the location of the image-capturing frame by the control button set 40 by himself/herself in the user defined mode and store the setting in the second digital camera 30.

When the user selects the section of the first image 50 within the image-capturing frame 52 on the electrical viewfinder 38 and presses the shutter button 36 to output a trigger signal to the logical unit 48, the logical unit 48 can store the first image 50 in the buffer 46 of the storage module 44 temporarily and store the selected section of the first image 50 stored in the buffer 46, the second image 54, in the storage module 44 after receiving the trigger signal, and delete the first image 50 stored in the buffer 46. If the logical unit 48 does not receive the trigger signal, the second image 54 cannot be stored in the storage module 44. For example if the shutter button 36 is two-staged, the focus, the exposure, and the white balance can be automatically determined when the shutter button 32 is pressed during the first stage. And when the shutter button 32 is pressed during the second stage, the trigger signal can be transmitted to the logical unit 48 to store the second image 54 in the storage module 44 under the conditions of the focus, the exposure, and the white balance decided at the first stage. If the shutter button 32 is not pressed during the second stage, the logical unit 48 cannot store the second image 54 in the storage module 44.

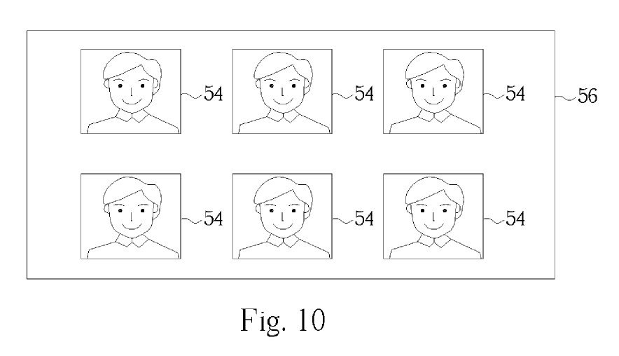

Please refer to FIG. 10. FIG. 10 is a diagram of a third image 56. The second image 54 can be duplicated as a plurality of copies and saved as an image file. That is, the third image 56 can be formed from the plurality of the second image 54 according to the size of the third image 56 and stored in the storage module 44 as an image file type. As shown in FIG. 10, the third image 56 is composed of the six second images. Therefore a plurality of passport size photographs can be integrated into an image file for printing conveniently.

The display module for displaying images is not limited to the electrical viewfinder 38, and it also can be a digital viewfinder or the image can be outputted to a monitor or a television. The present invention can be applied on other digital image capturing apparatuses, such as a digital camcorder, and is not limited to digital cameras.

In contrast to the prior art, the present invention allows users to operate the human machine interface of the digital camera to set the size of captured images for generating images in a desired size. Therefore users can obtain the image file in the desired size directly and print the image directly instead of downloading the image to a computer and utilizing an image processing software in the computer to modify the image.

Those skilled in the art will readily observe that numerous modifications and alterations of the device and the method may be made while retaining the teachings of the invention. Accordingly, the above disclosure should be construed as limited only by the metes and bounds of the appended claims.

1. An image-capturing system comprising:
a lens for capturing an image;
a storage module for storing the image;
a display module for displaying the image captured by the lens; and
a logical unit for displaying an image-capturing frame on the display module, selecting a section of the image displayed on the display device within the image-capturing frame, and storing the selected section of the image within the image-capturing frame in the storage module.

2. The image-capturing system of claim 1 further comprising a buffer to store the image captured by the lens temporarily.

3. The image-capturing system of claim 1 wherein the image captured by the lens is stored in a buffer of the storage module temporarily.

4. The image-capturing system of claim 1 further comprising a control button set for setting the size and the location of the image-capturing frame.

5. The image-capturing system of claim 1 wherein the size and the location of the image-capturing frame are adjustable.

6. The image-capturing system of claim 1 wherein the display module is an electrical viewfinder.

7. The image-capturing system of claim 1 wherein the display module is a digital viewfinder.

8. The image-capturing system of claim 1 wherein the display module is a monitor.

9. The image-capturing system of claim 1 wherein the display module is a television.

10. The image-capturing system of claim 1 wherein the image-capturing system is a digital camera.

11. The image-capturing system of claim 1 wherein the image-capturing system is a digital camcorder.

12. A method for capturing part of an image comprising:
capturing the image;
displaying the image;
displaying an image-capturing frame;
utilizing the image-capturing frame for selecting a section of the image; and
storing the selected section of the image.

13. The method of claim 12 further comprising storing the image temporarily, storing the selected section of the image separately, and deleting the image stored temporarily.

14. The method of claim 12 further comprising setting the size and the location of the image-capturing frame.

15. The method of claim 14 further comprising setting the size and the location of the image-capturing frame, storing the setting value, and storing the selected section of the image within the image-capturing frame according to the setting value.

16. The method of claim 15 further comprising adding a plurality of copies of the selected section of the image within the image-capturing frame into an image file, and storing the image file.
